(19) United States
(12) Patent Application Publication
(10) Pub. No.: US 2016/0162182 A1
(43) Pub. Date: Jun. 9, 2016

(54) Method and Terminal for Varying Keys of a Touch Keyboard

(71) Applicant: ZTE CORPORATION, Guangdong (CN)

(72) Inventor: Xin JIA, Guangdong (CN)

(21) Appl. No.: 14/903,754

(22) PCT Filed: Nov. 11, 2013
(86) PCT No.: PCT/CN2013/086876

§ 371 Date: Jan. 8, 2016

(30) Foreign Application Priority Data
Jul. 11, 2013 (CN) 201310290397.8

(51) Int. Cl. G06F 3/0488; G06F 3/041

(52) U.S. Cl. CPC G06F 3/04886; G06F 3/0418

(57) ABSTRACT

Provided are a method and a terminal for varying keys of a touch keyboard. The method includes: recording a click frequency of each of keys used by a user; setting a touch area for each of keys according to the click frequency of each of keys; and displaying a set touch keyboard on a screen. The terminal comprises: a recording element, a setting element and a displaying element. In the disclosure, by setting a touch area for each of keys according to the click frequency of each of keys, the touch area of a frequently-used key is increased, the probability of input errors is reduced, and the user experience is greatly improved.

### TECHNICAL FIELD

The disclosure relates to the technical field of communications, and in particular to a method and a terminal for varying keys of a touch keyboard.

### BACKGROUND

With the vigorous development of consumer electronic products, a device with a touch screen, such as tablet computer, mobile phone and Personal Digital Assistant (PDA), is growing on the market; each of terminals of touch-screen style (such as mobile phone) has a touch keyboard. With the wide usage of capacitive touch screens, people generally touch the screen to select and input characters by finger pads. However, since the area of the finger pad is relatively big, several characters are often touched by a single finger pad, thereby resulting in some troubles of input.

### SUMMARY

In view of the above analysis, the disclosure is intended to provide a method and a terminal for varying keys of a touch keyboard, to resolve a problem of inconvenience for the input by pressing the keys of the touch keyboard in related art.

The purpose of the disclosure is mainly realized by the following technical solutions.

A method for varying keys of a touch keyboard is provided, including: recording a click frequency of each of keys used by a user; setting a touch area for each of keys according to the click frequency of each of keys; and displaying a set touch keyboard on a screen.

In an example embodiment, the setting the touch area for each of keys according to the click frequency of each of keys includes: dividing the keys into multiple different grades, each of the grades corresponding to a certain touch area, and assigning each of keys to corresponding one of the grades respectively according to the click frequency of each of keys.

In an example embodiment, the method further includes: recording the click frequency of each of keys used by the user, when it is judged that a function for varying keys of a touch keyboard is enabled, after a keyboard touch event is received.

In an example embodiment, the touch area for each of keys is reset according to the click frequency of each of keys uniformly at a predetermined interval during usage of the touch keyboard.

In an example embodiment, a touch area for each of keys is set according to the last recorded click frequency of each of keys when the function for varying the keys of the touch keyboard is restarted.

The disclosure also provides a terminal applying any of the methods described above, including: a recording element, configured to record a click frequency of each of keys used by a user; a setting element, configured to set a touch area for each of keys according to the click frequency of each of keys; and a displaying element, configured to display a set touch keyboard on a screen.

In an example embodiment, the setting element is further configured to divide the keys into multiple different grades, each of the grades corresponding to a certain touch area, and to assign each of keys to corresponding one of the grades respectively according to the click frequency of each of keys.

In an example embodiment, the terminal further includes: a judgement element, wherein the judgement element is configured to trigger the recording element when it is judged that a function for varying keys of a touch keyboard is enabled, after a keyboard touch event is received.

In an example embodiment, the setting element is further configured to reset the touch area for each of keys according to the click frequency of each of keys uniformly at a predetermined interval during usage of the touch keyboard.

In an example embodiment, the setting element is further configured to set a touch area for each of keys according to the last recorded click frequency of each of keys when the function for varying the keys of the touch keyboard is restarted.

The disclosure has beneficial effects as follows: the method and the terminal for varying keys of a touch keyboard provided by the disclosure set a touch area for each of keys according to the click frequency of each of keys, thereby increasing the touch area of a frequently-used key, reducing the probability of input errors and greatly improving the user experience.

Other features and advantages of the disclosure are illustrated in the following specification, and partly become obvious from the specification or become understood by the implementation of the disclosure. The objects and other advantages of the disclosure may be realized and obtained through the structures indicated by the written specification, claims and accompanying drawings.

### BRIEF DESCRIPTION OF THE DRAWINGS

FIG. 1 is a flowchart of a method for varying keys of a touch keyboard according to Embodiment 1 of the disclosure;

FIG. 2 is a schematic diagram of a terminal touch keyboard according to Embodiment 1 of the disclosure;

FIG. 3 is a structure diagram of a terminal according to Embodiment 2 of the disclosure.

### DETAILED DESCRIPTION OF THE EMBODIMENTS

Drawings, provided for further understanding of the disclosure and forming a part of the specification, are used to explain the disclosure together with embodiments of the disclosure rather than to limit the disclosure. For the objects of clarification and simplification, the detailed description of the devices described in this application with functions and structures known by those skilled in the art will be omitted when the functions and structures may cause unclearness of the subject of the disclosure.

### Embodiment 1

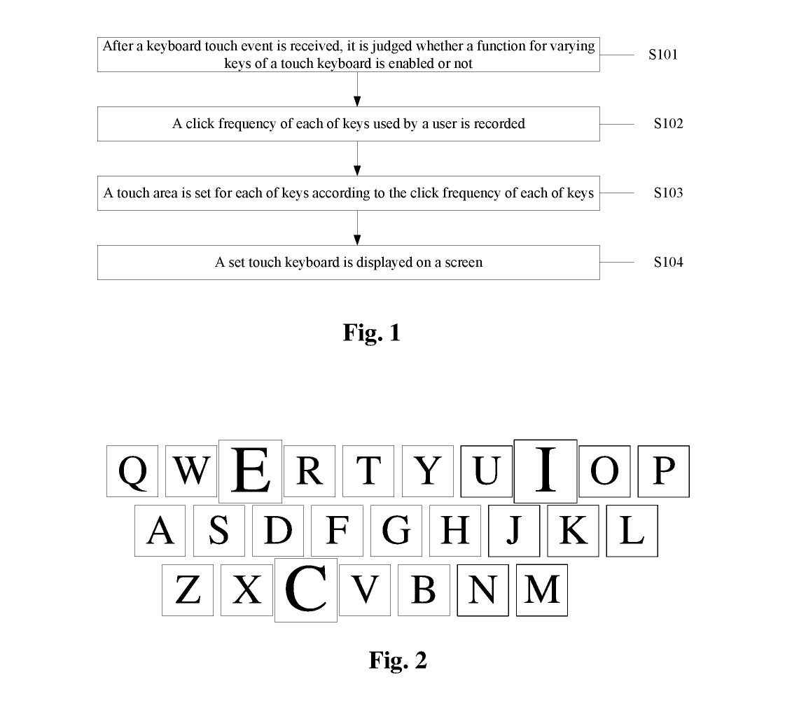

The embodiment of the disclosure provides a method for varying keys of a touch keyboard, which as shown in FIG. 1, the methods includes the following steps.

S101: after a keyboard touch event is received, it is judged whether a function for varying keys of a touch keyboard is enabled or not; if the function for varying the keys of the touch keyboard is enabled, the next step is entered.

S102: a click frequency of each of keys used by a user is recorded.

S103: a touch area is set for each of keys according to the click frequency of each of keys.

S103 includes: dividing the keys into multiple different grades, each of the grades corresponding to certain number of keys and corresponding to a certain touch area, and assigning each of keys to corresponding one of the grades respectively according to the click frequency of each of keys.

Of course, those skilled in the art also may make other settings as needed, for example, the touch area is set for each of keys in turn according to the click frequency of each of keys, and so on.

FIG. 2 is a schematic diagram of a terminal touch keyboard according to the embodiment of the disclosure. As shown in FIG. 2, the touch areas of part of the keys are enlarged for touching the keys by users conveniently.

S104: a set touch keyboard is displayed on a screen.

The embodiment of the disclosure may also set the touch area for each of keys according to the click frequency of each of keys uniformly at a predetermined interval, or a touch area for each of keys is set according to the last recorded click frequency of each of keys when the function for varying the keys of the touch keyboard is restarted.

The above method of the disclosure is described below in further detail with an example.

First, it is judged whether a function for varying keys of a touch keyboard is enabled or not; if the function for varying the keys of the touch keyboard is enabled, the next step is entered; otherwise, the process is ended.

A click frequency of each of keys is recorded, and a touch keyboard is drawn and displayed according to the click frequency of each of keys.

The method for varying keys of a touch keyboard provided by the disclosure sets the touch area for each of keys according to the click frequency of each of keys, thereby increasing the touch area of a frequently-used key, reducing the probability of input errors and greatly improving the user experience.

### Embodiment 2

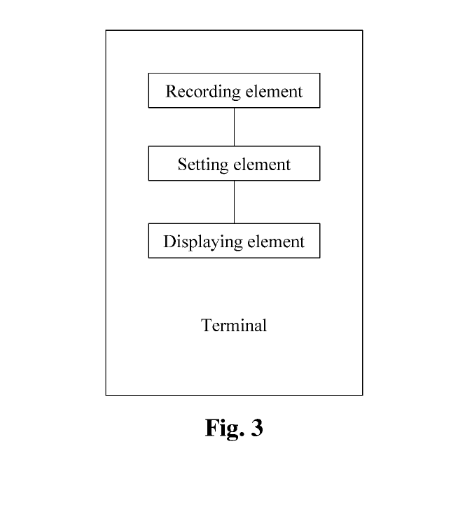

The embodiment of the disclosure provides a terminal as shown in FIG. 3, the terminal includes: a recording element, configured to record a click frequency of each of keys used by a user; a setting element, configured to set a touch area for each of keys according to the click frequency of each of keys; and a displaying element, configured to display a set touch keyboard on a screen.

### Implementation 1

The setting element is further configured to divide the keys into multiple different grades, each of the grades corresponding to certain number of keys and corresponding to a certain touch area, and to assign each of keys to corresponding one of the grades respectively according to the click frequency of each of keys.

### Implementation 2

A judgement element is configured to judge whether to enable a function for varying keys of a touch keyboard after a keyboard touch event is received, and to trigger the recording element if it is judged that the function for varying the keys of the touch keyboard is enabled.

### Implementation 3

The setting element is further configured to set the touch area for each of keys according to the click frequency of each of keys at a predetermined interval.

### Implementation 4

The setting element is further configured to set a touch area for each of keys according to the last recorded click frequency of each of keys when the function for varying the keys of the touch keyboard is restarted.

To sum up, the method and the terminal for varying keys of a touch keyboard provided by the disclosure can set a touch area for each of keys according to the click frequency of each of keys, thereby increasing the touch area of a frequently-used key, reducing the probability of input errors and greatly improving the user experience.

The above are the example embodiments of the disclosure; however, the protection scope of the disclosure is not limited to the above; any changes or substitutes that those skilled in the art can easily think out within the technical scope of the disclosure should fall into the scope of protection of the disclosure; therefore, the protection scope of the disclosure should be based on the protection scope of claims.

### INDUSTRIAL APPLICABILITY

To sum up, the method and the terminal for varying keys of a touch keyboard provided in the embodiments of the disclosure have the following beneficial effects: by setting a touch area for each of keys according to the click frequency of each of keys, the touch area of a frequently-used key is increased, the probability of input errors is reduced, and the user experience is greatly improved.

1. A method for varying keys of a touch keyboard, comprising:
recording a click frequency of each of keys used by a user;
setting a touch area for each of the keys according to the click frequency of each of the keys; and
displaying a set touch keyboard on a screen.

2. The method according to claim 1, wherein the setting the touch area for each of the keys according to the click frequency of each of the keys comprises:
dividing the keys into multiple different grades, each of the grades corresponding to a certain touch area, and assigning each of the keys to corresponding one of the grades respectively according to the click frequency of each of keys.

3. The method according to claim 1, wherein the recording the click frequency of each of the keys used by the user comprises:
recording the click frequency of each of keys used by the user, when it is judged that a function for varying keys of a touch keyboard is enabled, after a keyboard touch event is received.

4. The method according to claim 1, wherein the touch area for each of keys is reset according to the click frequency of each of keys uniformly at a predetermined interval during usage of the touch keyboard.

5. The method according to claim 1, wherein a touch area for each of keys is set according to the last recorded click frequency of each of keys when the function for varying the keys of the touch keyboard is restarted.

6. A terminal for varying keys of a touch keyboard, comprising:
a recording element, configured to record a click frequency of each of keys used by a user;
a setting element, configured to set a touch area for each of keys according to the click frequency of each of keys; and
a displaying element, configured to display a set touch keyboard on a screen.

7. The terminal according to claim 6, wherein the setting element is further configured to divide the keys into multiple different grades, each of the grades corresponding to a certain touch area, and to assign each of keys to corresponding one of the grades respectively according to the click frequency of each of keys.

8. The terminal according to claim 6, further comprising: a judgement element, wherein the judgement element is configured to trigger the recording element, when it is judged that a function for varying keys of a touch keyboard is enabled, after a keyboard touch event is received.

9. The terminal according to claim 6, wherein the setting element is further configured to reset the touch area for each of keys according to the click frequency of each of keys uniformly at a predetermined interval during usage of the touch keyboard.

10. The terminal according to claim 6, wherein the setting element is further configured to set a touch area for each of keys according to the last recorded click frequency of each of keys when the function for varying the keys of the touch keyboard is restarted.

11. The method according to claim 2, wherein the touch area for each of keys is reset according to the click frequency of each of keys uniformly at a predetermined interval during usage of the touch keyboard.

12. The method according to claim 3, wherein the touch area for each of keys is reset according to the click frequency of each of keys uniformly at a predetermined interval during usage of the touch keyboard.

13. The method according to claim 2, wherein a touch area for each of keys is set according to the last recorded click frequency of each of keys when the function for varying the keys of the touch keyboard is restarted.

14. The method according to claim 3, wherein a touch area for each of keys is set according to the last recorded click frequency of each of keys when the function for varying the keys of the touch keyboard is restarted.

15. The terminal according to claim 7, wherein the setting element is further configured to reset the touch area for each of keys according to the click frequency of each of keys uniformly at a predetermined interval during usage of the touch keyboard.

16. The terminal according to claim 8, wherein the setting element is further configured to reset the touch area for each of keys according to the click frequency of each of keys uniformly at a predetermined interval during usage of the touch keyboard.

17. The terminal according to claim 7, wherein the setting element is further configured to set a touch area for each of keys according to the last recorded click frequency of each of keys when the function for varying the keys of the touch keyboard is restarted.

18. The terminal according to claim 8, wherein the setting element is further configured to set a touch area for each of keys according to the last recorded click frequency of each of keys when the function for varying the keys of the touch keyboard is restarted.

19. The method according to claim 1, wherein the click frequency of each of the keys comprises at least one of: an error click frequency and a correct click frequency, wherein the error click frequency of a key is the times of clicking another key in a certain period of time by mistake when the key is needed to be clicked, and the correct click frequency of the key is the times of clicking the key in a certain period of time when the key is needed to be clicked.
